(19) United States
(12) Patent Application Publication
(10) Pub. No.: US 2008/0306857 A1
(43) Pub. Date: Dec. 11, 2008

(54) Method for displaying transmission time intervals of orders on electronic trading system

(75) Inventor: Andrew William Busby, Aurora, IL (US)

Correspondence Address: MCGUIREWOODS, LLP, 1750 TYSONS BLVD, SUITE 1800, MCLEAN, VA, 22102, US

(73) Assignee: Cunningham Trading Systems, LLC

(21) Appl. No.: 11/808,367

(22) Filed: Jun. 8, 2007

(51) Int. Cl. G06Q 40/00

(52) U.S. Cl. 705/37

(57) ABSTRACT

A method is provided for displaying transmission time intervals to a trader using an electronic trading system comprising the steps of displaying a trading screen for an electronic trading system, said trading screen including a transmission time interval display, and displaying a transmission time interval on the transmission time interval display. The transmission time interval comprises an order transmission time interval and a confirmation transmission time interval. The order transmission time interval includes an order transmission to proceed from a client computer to the electronic commodity exchange. The confirmation transmission time interval includes time for a confirmation transmission to proceed from the electronic commodity exchange to the client computer. The method may further comprise the steps of transmitting an order transmission from a client computer to an electronic trading exchange, receiving a confirmation transmission from the electronic commodity exchange by the client computer, and determining the transmission time interval.

### FIELD OF THE INVENTION

The present invention relates to a method for communicating trading information on an electronic trading system, and more particularly, to a method for displaying transmission time intervals of orders on an electronic trading system.

### BACKGROUND OF THE PRESENT INVENTION

Commodities have been traded in the same way for hundreds of years. The Chicago Board of Trade (“CBOT”) began trading commodities in the 1800's. Since the inception of the CBOT, many different exchanges all over the world have been created that trade commodities.

Due to the recent evolution of the internet, electronic commodity trading has become a standard feature of exchanges. This has permitted vast accessibility to various exchanges without requiring that a user be present within the exchange and without the necessity of “paper trades.” Not only has the use of electronic trading greatly increased the ability for users to trade commodities, but electronic trading has also increased the volatility of the exchanges, since there are more users that have easier and faster access to the exchanges.

Electronic trading of commodities is achieved through a combination of exchange hosts, internet service providers (“ISPs”) and application service providers (“ASPs”). The exchange hosts are primarily responsible for order routing, price dissemination and connectivity.

The ASPs that are utilized in electronic commodities trading are responsible for, among other things, maintaining connectivity, hosts and clients. Connectivity is maintained with respect to exchange hosts through bidirectional communication with redundancy. The hosts are responsible for risk management throughout the trading day as well as the backoffice integration/imports. Hosts also are responsible for connectivity of the client session management, price dissemination and order routing.

The client is what the user interacts with directly. The client is responsible for connectivity through the internet or through direct connection to the hosted server environment. The client includes a session management feature which will monitor client connectivity to the hosted server environment. Moreover, the client will typically include a configurable display that includes prices not only of the last trade, but also of the depth of market. The client also allows the user to manipulate orders, keep track of an order book and monitor account status, including balances, profit and loss and positions. Each of the exchanges has requirements in order for the hosts and the clients to participate in the market. While the exchange interface is the same for all participants, the different ASPs and proprietary systems interfaces can and do differ.

Different commodity trading companies typically include a custom trading front-end or platform which each company markets as providing a trading advantage over another commodity trading company. The general advantages an individual trader is seeking are speed and accuracy. Thus, a commodity trading company having a front-end platform that increases speed and accuracy over competing front-end platforms will give that commodity trading company a marketing advantage.

The time required between submission of a trade order by a user on a client computer, receipt and entry on an appropriate commodity exchange, and transmitting a confirming replay back to the client computer which is displayed for the user, is critical for many traders and can be the difference between making and losing money in the highly competitive and time-sensitive environment of electronic trading systems.

Numerous front-end exchange vendors claim their systems are fast and claim to produce statistics to back up this claim. However, like many statistics, it is unclear exactly where the data for these statistics come from and the details used to calculate each statistic. For example, in regard to submission times, vendors are unclear whether their statistics measure the time between a user clicking the button on his computer to enter the order and the display of the order confirmation, or between a different time segment. Furthermore, the time accuracy may also be a factor in comparing different front-end vendors. The standard Windows timer typically only goes down to 15 milliseconds, but high-performance multi-media timers can go below 1 millisecond. Even if different vendors use the same timing methods, the performance of an individual user's computer can affect the time to enter and receive confirmation of an order. Similarly, the speed of the connecting server and network to which a user is connected can affect the order time.

Additionally, a vendor may be providing statistics that represent an ideal condition, which is not generally the situation in a typical trading day. Traders using electronic exchanges deal with many factors affecting the entry of their orders outside their control, such as the speed of the servers, a particular time of day, and the numbers of traders using the network at that particular time, which can all affect the time for submitting orders to an exchange.

Trading submission times during average traffic can occur in less than 100 milliseconds, but during busy trading periods, the submission time can become several seconds. Conventional front-end systems do not provide real-time statistics to traders indicating how fast an order has been submitted or where in the order submission process delays are occurring, such as a delay in the exchange, a trader's computer, or the servers. If trade history data is provided by conventional exchange vendors, such data is not detailed enough to provide the troubleshooting information necessary to identify the location of a delay, whether it be the exchange, the user's computer, or the user's connection.

Accordingly, based on the foregoing, it would be highly desirable to provide a method and system enabling commodity trading companies to provide features on their front-end platform that provides users with real-time order transmission time intervals for the various stages of an order submission process on an electronic commodity exchange, thereby enabling a user to evaluate their own order submission performance, and if there are any delays, to identify where in the submission process such delays are occurring.

### OBJECTS AND SUMMARY OF THE INVENTION

In view of the foregoing, an object of the present invention is to provide a front-end platform that enables a trader or observer to have access to real-time data indicating transmission time intervals for order transmissions on an electronic commodity exchange between entry of an order on a user's computer and receipt of a confirmation of the order from the electronic commodity exchange.

Another object of the present invention is to enable a user or observer to receive real-time data indicating transmission time intervals for an order submission between various transmission time segments of a multi-tier electronic trading system.

A further object of the present invention is to enable a user to determine if any delays are occurring in the order submission process, and if there are any delays, at what transmission segment of the multi-tier electronic trading system the delays are occurring.

In accordance with the present invention, a method is provided for displaying transmission time intervals to a trader using an electronic trading system comprising the steps of displaying a trading screen for an electronic trading system, said trading screen including a transmission time interval display, and displaying a transmission time interval on the transmission time interval display. The transmission time interval comprises an order transmission time interval and a confirmation transmission time interval. The order transmission time interval includes time for an order transmission to proceed from a client computer to the electronic commodity exchange. The confirmation transmission time interval includes time for a confirmation transmission to proceed from the electronic commodity exchange to the client computer. The method may further comprise the steps of sending an order transmission from a client computer to an electronic trading exchange, receiving a confirmation transmission from the electronic commodity exchange by the client computer, and determining the transmission time interval.

Other features and advantages of the present invention will become apparent to those skilled in the art from the following detailed description. It should be understood that the detailed description and specific examples, while indicating the preferred embodiment of the present invention, are given by way of illustration and not limitation. Many changes and modifications within the scope of the present invention may be made without departing from the spirit of the invention, and the invention includes all such modifications.

### BRIEF DESCRIPTION OF THE DRAWINGS

FIG. 1 a flowchart of a preferred method configured in accordance with the present invention;

FIG. 2 illustrates network connections between multiples exchanges and a client computer configured in accordance with a preferred embodiment of the present invention;

FIG. 3 is an enlarged view of the transmission time interval display shown in FIG. 2;

FIG. 4a is an enlarged view of the vertical timing bar graphs for the transmission time segments shown in FIG. 3; and

FIG. 4b is a block diagram of transmission time segments corresponding to the vertical timing bar graphs shown in FIG. 4a.

### DETAILED DESCRIPTION OF THE PREFERRED EMBODIMENT

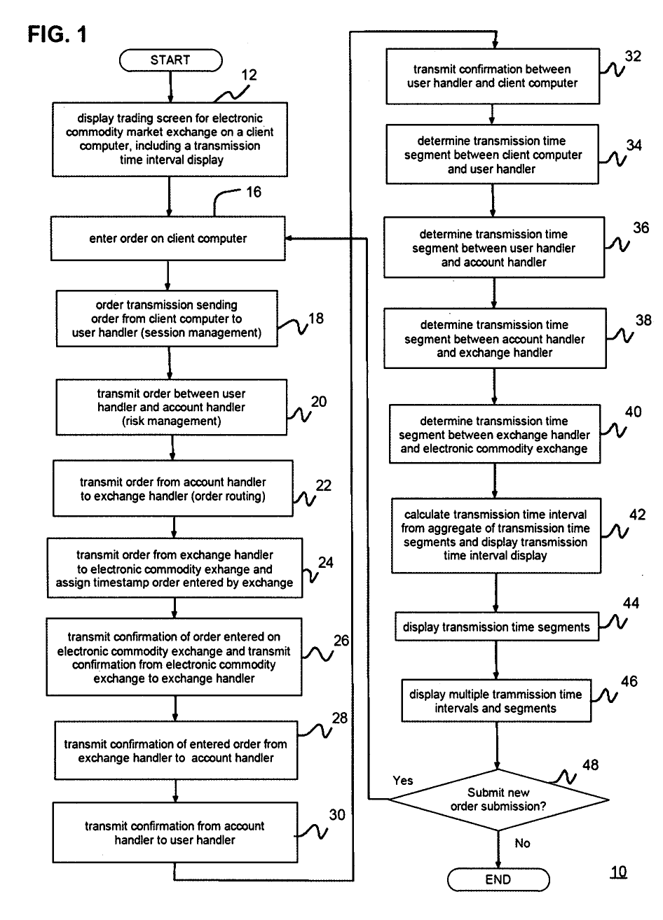

Referring now to the drawings, FIG. 1 shows a flowchart of the preferred method configured in accordance with the present invention. In the preferred embodiment, the method of the present invention is implemented over the internet using a client computer or electronic terminal in combination with an electronic commodity exchange. The client computer is able to communicate directly or indirectly via intermediate devices with an exchange to receive and transmit market, commodity, and trading order information. The present invention is preferably implemented on any existing or future terminal or device with the processing capability to perform the functions described herein. The scope of the present invention is not limited to the type of terminal or device used. Furthermore, the present invention is not necessarily used on the internet.

Turning now to the flowchart 10 in FIG. 1, the preferred method of the present invention begins at step 12 wherein a client computer displays a trading screen for an electronic commodity exchange, and the trading screen display includes a transmission time interval display. Next at step 16, a user or trader enters an order on the client computer. The specific type of entered order transmission could be an order submission, an order revision, a pull order, or a cancellation order, which are transmitted from the client computer to the electronic commodity exchange.

After the order is entered into the client computer, the order is transmitted from the client computer to the user handler at step 18. The client computer and the user handler define a segment between the complete transmission path from the client computer to the electronic commodity exchange. The next segment for an order transmission is at step 20, wherein the order proceeds from the user handler to the account handler. An order transmission carries the entered order between all of the segments along the transmission path from the client computer to the electronic commodity exchange.

The order proceeds to the next segment, which is between the account handler and the exchange handler at step 22. From there, the order proceeds to the final segment which is defined by the exchange handler and the electronic commodity exchange at step 24, wherein the electronic commodity exchange assigns a time stamp to the order identifying when the order was received and entered by the electronic commodity exchange.

After the electronic commodity exchange has received and entered the order from the client computer, the electronic commodity exchange then transmits a confirmation of the order being entered and received by the exchange back along the same path to the client computer. At step 26, the confirmation is transmitted in a confirmation transmission from the electronic commodity exchange to the exchange handler. Next, at step 28, the confirmation proceeds from the exchange handler to the account handler. In step 30, the confirmation travels to the next segment from the account handler to the user handler. Finally, the confirmation proceeds from the user handler to the client computer at step 32.

At step 34, the database stores the time at which the transmission passes from one segment to the next for both the order transmission and the confirmation transmission, which enables calculation of the individual transmission segments of the transmission path between the client computer and the electronic commodity exchange. The first transmission time segment to be determined occurs between the client computer and the user handler occurs at step 34. A transmission time segment is defined as the time for both an order transmission and a corresponding return confirmation transmission to travel across the same segment, such as the client computer and the user handler. Next, at step 36, the transmission time segment is determined between the user handler and the account handler. At step 38, the transmission time segment is determined between the account handler and the exchange handler. Similarly, at step 40, the transmission time segment is determined between the exchange handler and the electronic commodity exchange.

At step 42 the transmission time interval is calculated by combining the aggregate of each of the separate transmission time segments between the client computer and the electronic commodity exchange. Next, at step 44, the individual transmission time segments are displayed. At step 46, the transmission time interval is displayed. If more than one order has been submitted, multiple transmission time intervals are displayed.

At step 48, the method checks to determine if a new order submission is being requested. If a trader desires to submit a new order, then the method returns back to step 16 wherein a new order is entered on the client computer, and a new order submission will proceed sending the order from the client computer to the electronic commodity exchange. Additional order submissions will follow the same steps as previously described. If more than one order submissions occurs, then the preferred method may display multiple transmission time intervals and segments at step 46. If no new order submission are submitted at step 48, than the method will terminate.

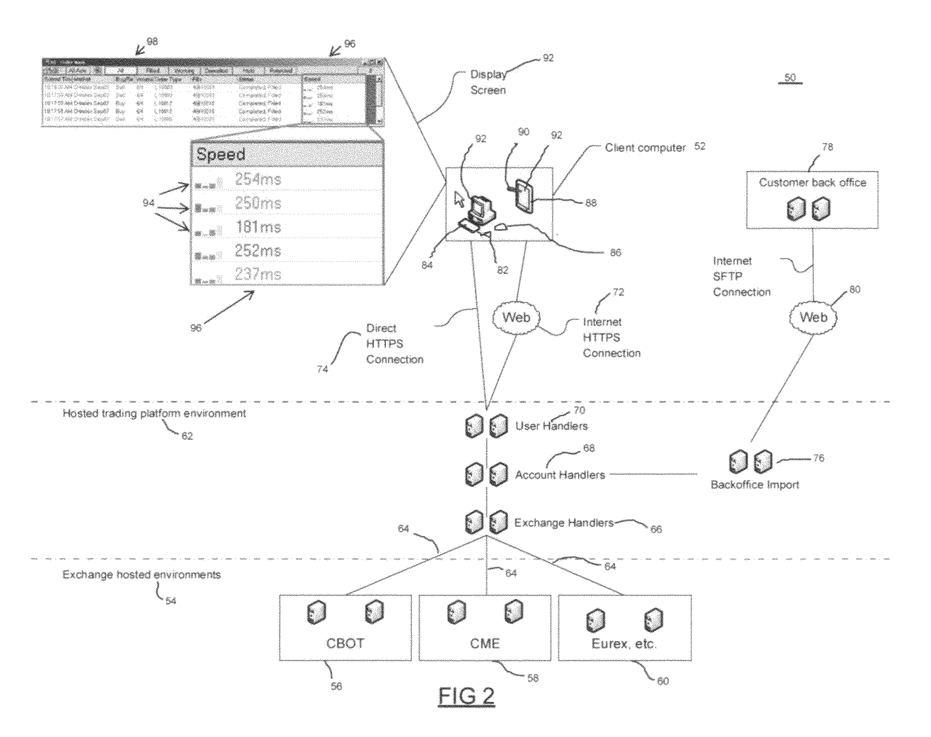

FIG. 2 illustrates a network connection 50 between multiple exchanges and a client computer 52 configured in accordance with a preferred method of the present invention. Several exchange hosted environments 54 are illustrated, including the Chicago Board of Trade (CBOT) 56, the Chicago Mercantile Exchange (CME) 58, and the European Electronic Exchange (Eurex) 60. The various exchange hosted environments 54 are connected to a hosted trading platform environment 62 via direct copper or fiber connections 64. Specifically, the exchange hosted environments 56, 58, 60 interface directly with exchange handlers 66 via the direct connections 64. Software applications for use with the hosted trading platform environment 62 of the present invention also preferably include a server component. The server component is preferably an n-tier distributed application that is designed to be robust, secure and scalable. The server preferably consists of a number of tiers, including an exchange handler 66, an account handler 68, and a user handler 70. Each of the handlers 66, 68, 70 can be run on separate servers, or they can all be run on the same server, or any combination thereof. Multiple instances of each tier can be run at the same time to achieve load balancing and failover redundancy. Each tier communicates with the others using messages sent over TCP/IP sockets, multicast or Microsoft Message Queue services.

The exchange handler 66 typically communicates with the futures exchanges, such as the CBOT 56, the CME 58, and the Eurex 60. This tier effectively provides a common interface for the rest of the applications to communicate with different exchange technologies (such as LIFFE Connect, FIX, etc.). For each exchange that the system communicates with, a driver is typically created that deals with the translation between that specific exchange application program interface (API) and the varying data formats of the software application. The driver updates caches of information within the exchange handler 66 with updates to that market data, quotes or orders. The exchange handler 66 typically then deals with forwarding that information onto the account handlers 68 and user handlers 70 based on what information they have subscribed to receive.

The account handler 68 is preferably at the core of the system holding all account related information including orders for the current day. The orders submitted by a user are typically sent through the account handler 68 and checked for various risk management parameters, such as maximum size, margin requirement, etc., before being sent to an exchange handler 66 for sending to the actual exchange. When an order is confirmed by an exchange, or is filled or cancelled, the message is forwarded from the exchange, via the exchange handler 66, to the account handler 68, where an order record is updated to reflect the new state of the order. The updated order state is then sent to the end-user via the user handler 70.

Servers for use with the present invention preferably include a user handler 70. The user handler 70 typically deals with the connections established by the end-users with the front-end, typically via the API. Access to the system by an end-user is preferably achieved through this component. The user handler 70 preferably maintains a secure connection with a client computer 52 via SSL encryption over an internet HTTPS connection 72 or a direct HTTPS connection 74, which enables authentication of the user of client computer 52 and the permissions that the user of client computer 52 has been assigned. It is contemplated that other means of maintaining a secure connection and authenticating users and permission may be implemented as would be appreciated by those of ordinary skill in the art.

Quote data from the exchanges and the order and trade confirmations from the account handler 68 are preferably forwarded through the user handler 70 to the end-users depending on the data that each user has subscribed to. Orders submitted and requests for data from the end-user are typically processed through the user handler 70 first, and then forwarded to the appropriate account handler 68 or exchange handler 66.

It is advantageous to have many instances of the user handler 70 tier, preferably on multiple machines, which would allow for hundreds or thousands of users to be connected to the system at the same time. If one instance failed, the users connected to it would automatically reconnect to another instance causing minimal outage time for the end-user.

The backoffice import 76 allows the hosted environment 62 to import account details (number, name, balance, etc.) and statements from the customers backoffice system 78. This import is in the form of a FTP or SFTP. The hosted trading platform environment preferably adds or updates account details and publishes statements on the web in the form of PDF's so that a user on a client computer 52 can access all their account related information from the company providing the hosted trading platform 62 via the web. The customer backoffice 78 provides a source for the SFTP to the backoffice import 76 via the internet 80.

The client computer 52 interfaces with the user handler 70 of the hosted trading platform 62 via the internet 72 or a direct connection 74. The client computer 52 is preferably a desktop computer having a mouse 82 and keyboard 84 as input devices. The client computer 52 also is capable to receiving and reading a computer readable medium, such as a compact or floppy disk 86. In another embodiment the client computer 52 may be a flat panel touch pad computer 88 using a touch pen 90 as an input device. Of course, other types of client computers 52 and input devices may be used with the present invention to display and make inputs on a trading screen display 92.

In accordance with the present invention, a trading screen 92 for an electronic trading system is provided for displaying transmission time intervals 94 on the trading screen 92. In the preferred embodiment, the transmission time intervals 94 are displayed in an additional column 96 of a trader's order book 98.

FIG. 2 includes a view of the order book 98 including the additional column 96 displaying multiple transmission time intervals 94. The transmission time intervals in new column 96 of the order book 98 are shown on the trading screen 92.

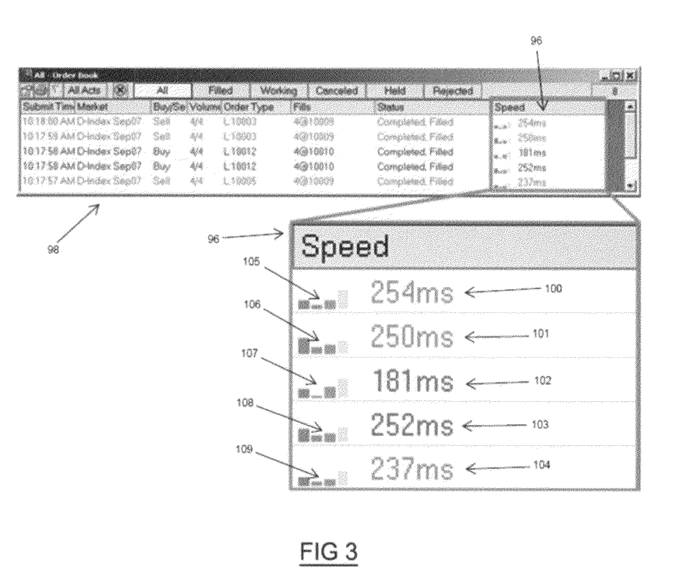

FIG. 3 provides an enlarged view of the order book 98 and the new column 96 showing multiple transmission time intervals 100, 101, 102, 103, 104. Each transmission time interval 100-104 corresponds to a separate order transmission and confirmation transmission for an individual order entered on the client computer 92. The transmission time intervals 100-104 are displayed in milliseconds, but other timing formats can be used. Also illustrated in the transmission time interval column or speed column 96 are multicolored vertical bar graphs 105, 106, 107, 108, 109 indicating the transmission time segments for each order entered on the client computer 92. Preferably, a transmission time interval corresponding to the most recently entered order is listed at the top of the speed column 96, the next most recent transmission time interval is listed next, and so forth.

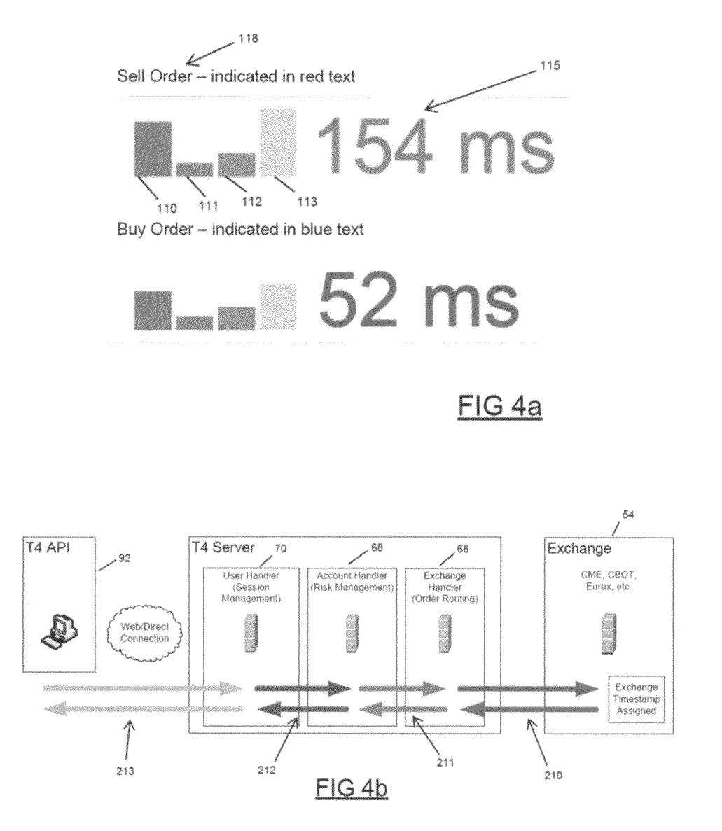

FIG. 4a provides an enlarged view of the multicolored vertical bar graphs shown in FIG. 3. Each of the vertical bar graphs 110, 111, 112, 113 correspond to a separate transmission time segment 210, 211, 212, 213 (FIG. 4b) between the client computer 92 and the electronic commodity exchange 54. The aggregate of the transmission time segments 210,211,212,213, represented by the vertical bar graphs 110,111,112,113, equal the transmission time interval 115.

In the illustrated embodiment of FIG. 4a, the green vertical bar graph 110 indicates the relative transmission time segment of an order transmission and a confirmation transmission proceeding between the electronic commodity exchange 54 and the exchange handler 66. The red vertical bar graph 111 indicates the relative transmission time segment of an order transmission and a confirmation transmission proceeding between the exchange handler 66 and the account handler 68. Similarly, the blue vertical bar graph 112 indicates the relative transmission time segment of an order transmission and a confirmation transmission proceeding between the account hander 68 and the user handler 70. The grey vertical bar graph 113 indicates the relative transmission time segment of an order transmission and a confirmation transmission proceeding between the user handler 70 and the client computer 92.

Referring now to FIGS. 4a and 4b, for sell order example 118, the grey vertical bar graph 113 indicates the transmission time segment 213 between the client computer 92 and the user handler 70 is currently taking the longest period of time relative to the other transmission time segments. Similarly, the red vertical bar graph 111 in the sell order example 118 indicates the transmission time segment 211 between the account handler 68 and the exchange handler 66 is taking the shortest period of time relative to the other transmission time segments.

Based on a review of vertical bar graphs 110-113 and the transmission time interval time 115 shown in the speed column 96 of the order book 98, a trader or observer, based the on the provided real-time data, can immediately determine the time it is taking for his or her order to be processed, and if there are any delays in the transmission process, determine at which transmission time segment a delay is occurring.

It should be understood that the above description of the present invention and preferred embodiment are given by way of description and illustration, and not limitation. Many changes and modifications within the scope of the present invention may be made without departing from the spirit of the present invention, and the present invention includes all such changes and modifications.

I claim as my invention:

1. A method for displaying transmission time intervals to a trader using an electronic trading system, said method comprising the steps of:
displaying a trading screen for an electronic trading system, said trading screen including a transmission time interval display; and
displaying a transmission time interval on the transmission time interval display.

2. The method of claim 1, wherein said transmission time interval includes an order transmission time interval and a confirmation transmission time interval.

3. The method of claim 2, wherein said order transmission time interval includes time for an order transmission to proceed from a client to an exchange.

4. The method of claim 2, wherein said confirmation transmission time interval includes time for a confirmation transmission to proceed from an exchange to a client.

5. The method of claim 3, wherein said order transmission includes an order submission.

6. The method of claim 3, wherein said order transmission includes an order revision.

7. The method of claim 3, wherein said order transmission includes an order cancellation.

8. The method of claim 4, wherein said confirmation transmission includes a confirmation submission.

9. The method of claim 4, wherein said confirmation transmission includes a confirmation revision.

10. The method of claim 4, wherein said confirmation transmission includes a confirmation cancellation.

11. The method of claim 1, further comprising the steps of:
transmitting an order transmission from a client to an exchange;
receiving a confirmation transmission from the exchange by the client; and
determining the transmission time interval.

12. The method of claim 11, further comprising the steps of:
transmitting a second order transmission from the client to the exchange;
receiving a second confirmation transmission from the exchange by the client; and
determining a second transmission time interval.

13. The method of claim 12, further comprising the steps of:
removing the first transmission time interval from the transmission time interval display; and
displaying the second transmission time interval on the transmission time interval display.

14. The method of claim 12, further comprising the step of:
displaying both the first and second transmission time intervals on the transmission time interval display.

15. The method of claim 14, further comprising the step of:
displaying the second transmission time interval above the first transmission time interval on the transmission time interval display.

16. The method of claim 1, further comprising the step of:
displaying multiple transmission time intervals on the transmission time interval display.

17. The method of claim 1, further comprising the step of:
displaying multiple transmission time intervals on the transmission time interval display, wherein the transmission time interval of the most recently submitted order submission is listed first.

18. The method of claim 1, wherein the electronic trading system utilizes an electronic trading commodity exchange.

19. The method of claim 1, wherein the transmission time interval is displayed in a graph format.

20. The method of claim 1, wherein the transmission time interval is displayed in a bar graph format.

21. The method of claim 1, wherein the transmission time interval is displayed as an annotation to the graph format.

22. The method of claim 1, wherein the electronic trading system utilizes a multi-tier system, further comprising the step of:
displaying multiple transmission time intervals corresponding to various transmission time segments of the multi-tier electronic trading system.

23. The method claim 3, wherein the order transmission is transmitted over the internet.

24. The method of claim 4, wherein the confirmation transmission is transmitted over the internet.

25. The method claim 3, wherein the order transmission is transmitted over a dedicated connection between a client computer and a trading platform.

26. The method of claim 4, wherein the confirmation transmission is transmitted over a dedicated connection between a client computer and a trading platform.

27. A method for displaying order transmission time intervals over an electronic trading system to an observer, said method comprising the steps of:
displaying an information screen for an electronic trading system, said information screen including a transmission time interval display; and
displaying a transmission time interval on the order transmission time interval display.

28. The method of claim 27, wherein the observer is a system administrator for the electronic trading system.

29. The method of claim 27, wherein the observer is an independent third party of the electronic trading system.

30. The method of claim 27, wherein said transmission time interval includes an order transmission time interval and a confirmation transmission time interval.

31. The method of claim 30, wherein said order transmission time interval includes time for an order transmission to proceed from a client to an exchange.

32. The method of claim 30, wherein said confirmation transmission time interval includes time for a confirmation transmission to proceed from an exchange to a client.

33. The method of claim 31, wherein said order transmission includes an order submission.

34. The method of claim 31, wherein said order transmission includes an order revision.

35. The method of claim 31, wherein said order transmission includes an order cancellation.

36. The method of claim 32, wherein said confirmation transmission includes a confirmation submission.

37. The method of claim 32, wherein said confirmation transmission includes a confirmation revision.

38. The method of claim 32, wherein said confirmation transmission includes a confirmation cancellation.

39. The method of claim 27, further comprising the steps of:
transmitting an order transmission from a client to an exchange;
receiving a confirmation transmission from the exchange by the client; and
determining the transmission time interval.

40. The method of claim 39, further comprising the steps of:
transmitting a second order transmission from the client to the exchange;
receiving a second confirmation transmission from the exchange by the client; and
determining a second transmission time interval.

41. The method of claim 40, further comprising the steps of:
removing the first transmission time interval from the transmission time interval display; and
displaying the second transmission time interval on the transmission time interval display.

42. The method of claim 40, further comprising the step of:
displaying both the first and second transmission time intervals on the transmission time interval display.

43. The method of claim 42, further comprising the step of:
displaying the second transmission time interval above the first transmission time interval on the transmission time interval display.

44. The method of claim 27, further comprising the step of:
displaying multiple transmission time intervals on the transmission time interval display.

45. The method of claim 27, further comprising the step of:
displaying multiple transmission time intervals on the transmission time interval display, wherein the transmission time interval of the most recently submitted order submission is listed first.

46. The method of claim 27, wherein the electronic trading system utilizes an electronic trading commodity exchange.

47. The method of claim 27, wherein the transmission time interval is displayed in a graph format.

48. The method of claim 27, wherein the transmission time interval is displayed in a bar graph format.

49. The method of claim 27, wherein the transmission time interval is displayed as an annotation to the graph format.

50. The method of claim 27, wherein the electronic trading system utilizes a multi-tier system, further comprising the step of:
displaying multiple transmission time intervals corresponding to various transmission time segments of the multi-tier electronic trading system.

51. The method claim 31, wherein the order transmission is transmitted over the internet.

52. The method of claim 32, wherein the confirmation transmission is transmitted over the internet.

53. The method claim 31, wherein the order transmission is transmitted over a dedicated connection between a client computer and a trading platform.

54. The method of claim 32, wherein the confirmation transmission is transmitted over a dedicated connection between a client computer and a trading platform.

55. A computer readable medium having program code recorded thereon for execution on a computer for placing an order submission on an electronic trading commodity exchange, said program code causing a machine to execute a method comprising the steps of:
displaying a trading screen for an electronic trading commodity exchange, said trading screen including an order transmission time display; and
displaying an order transmission time on the order transmission time display.
